(19) United States
(12) Patent Application Publication
(10) Pub. No.: US 2025/0119697 A1
(43) Pub. Date: Apr. 10, 2025

(54) DETECTING INTERFERENCE WITH SOUND SENSING DEVICES

(71) Applicant: Alarm.com Incorporated, Tysons, VA (US)

(72) Inventors: Matthew Daniel Correnti, Newtown Square, PA (US); Joseph Gardner Fiveash, IV, Washington, DC (US)

(21) Appl. No.: 18/894,053

(22) Filed: Sep. 24, 2024

Related U.S. Application Data
(60) Provisional application No. 63/542,318, filed on Oct. 4, 2023.

(51) Int. Cl. H04R 29/00; H04R 3/00

(52) U.S. Cl. CPC H04R 29/006; H04R 3/005

(57) ABSTRACT

Method, systems, and apparatus, including computer programs encoded on computer storage media, for detecting interference with sound sensing devices. One of the methods includes receiving, from a sound sensing device at a property, an audio signal captured by the sound sensing device; obtaining, from one or more other devices at the property, data; determining whether an audio event likely occurred at the property using the obtained data; in response to determining that an audio event likely occurred at the property, determining, using the audio signal captured by the sound sensing device and event data for the audio event, whether a configuration of the sound sensing device is likely modified; and in response to determining that the configuration of the sound sensing device is likely modified, performing one or more actions for the modification of the configuration of the sound sensing device at the property.

### CROSS-REFERENCE TO RELATED APPLICATION

This application claims the benefit of U.S. Provisional Application No. 63/542,318, filed on Oct. 4, 2023, the contents of which are incorporated by reference herein.

### TECHNICAL FIELD

This specification relates generally to monitoring sound sensing devices.

### BACKGROUND

A home network is a type of network that facilitates communication among devices within a close vicinity of a home. Devices capable of interacting over a home network can interact with one another and provide useful information to homeowners. The home network can be secure, such that individuals external to the home cannot access or view data personal to the homeowners and their devices.

### SUMMARY

In some implementations, the technology of this specification relates to mitigating interference with sound sensing devices. A sound sensing device can be used to detect various disruptions at a particular property, such as a residential property, a business property, and entertainment events. For instance, a sound sensing device can detect noise at a particular property and perform a corresponding action.

However, issues may arise that can compromise the effectiveness of the sound sensing device. A system can monitor and detect when such issues likely arise with the sound sensing device and execute one or more corrective actions to ensure the effectiveness of the sound sensing device is not compromised. For example, the system can detect likely intentional or unintentional interference, encasement, tampering or a combination of these that can reduce an ability of the sound sensing device to detect disruptions at a property.

A priority for some property managers of a property can include the detecting, preventing, and mitigating of noise disruptions at the property. Property managers may face fines from noise violations attributed to rental owners or guests and can suffer other negative impacts relating to their property. These other negative impacts can include, for example, a loss of reputation in the community, a poor experience for guests, and heavy fines to pay, to name some examples.

To reduce a likelihood of these negative impacts, one or more sound sensing devices can be positioned at different locations around the interior and exterior of the monitored property. In this manner, the one or more sound sensing devices can listen and record the disruptions to ensure the disruptions are detected and quickly acted upon. A system can receive and monitor the disruptions heard by each of the one or more sound sensing devices at the monitored property to increase a likelihood that the sound sensing devices remain effective.

In further detail, a sound sensing device can monitor the decibel level of its environment. The sound sensing device can monitor the decibel level of their surrounding environment and notify property owners, staff, security guards, systems, and other types of entities depending on the environment, of the monitored decibel level upon request or on a periodic basis. During this monitoring process, the system can analyze the measured decibel level to determine whether tampering has likely occurred with the sound sensing device.

For example, people may adjust or tamper with the sound sensing device to avoid being flagged for disruptive noise violations, such as during a loud party. People can: unplug or destroy the sound sensing device, tamper or damage the sound sensing device, encase the sound sensing device to muffle the recording capability of the sound sensing device, and move the sound sensing device to an isolated part of the property, e.g., inside a closet. Accordingly, the technology described in this specification enables monitoring and detecting when such tampering of a sound sensing device likely occurs. In response to detecting likely issues with the sound sensing device, a system can conduct various corrective actions to address the detected issues.

In some cases, the system may conduct calibration events to detect whether the sound sensing device has been modified or tampered with. For example, various devices at the property, e.g., a heating, ventilation, and air conditioning (HVAC) system, a sensor, water pump, washing machine, a camera, and others, can generate various noises that can be independently verified by other devices within the property. If the system determines that a noise event has been independently verified and the noise level of the noise event as recorded by the sound sensing device is not within a threshold range of a noise calibration event, the system can generate an alert that one or more sound sensing devices may be compromised. Some independently verified events can include, for example, an HVAC running verified by a thermostat, a deadbolt locking verified by a smart lock, toilet flushing verified by a smart meter, and doorbell chimes verified by a doorbell camera, to name a few examples.

In some cases, the system can monitor various characteristics of a sound sensing device within a monitored property to determine whether tampering has occurred. For example, the system can determine whether (i) a drop in the sound sensing device's Z-wave signal strength has occurred over a period of time; (ii) a drop in ambient background noise in a monitored property has occurred; and (iii) a temperature of a sound sensing device over a period of time has changed a threshold amount, e.g., increased, to name some examples. If the system detects whether one of these events has likely occurred, the system can conduct a calibration operation to determine whether the sound sensing device has been likely modified, signal an alert to an owner of the property that the sound sensing device has likely been modified, or both.

If the system detects that the characteristics of the sound sensing device do not satisfy a tampering threshold, the system can determine one or more actions to assess and potentially correct an error with the sound sensing device. In some examples, the server can dispatch a drone to traverse the monitored property to capture imagery of the potentially faulty sound sensing device. In some examples, the server can notify a property owner of the potentially faulty sound sensing device. In some examples, the server can notify the individuals in the monitored property that one or more tests are being performed to check on a sound sensing device that appears to be faulty. In some examples, the system can perform one or more automated actions to attempt to correct a potential issue with a sound sensing device. Other examples are also possible.

In general, one aspect of the subject matter described in this specification can be embodied in methods that include the actions of receiving, from a sound sensing device at a property, an audio signal captured by the sound sensing device; obtaining, from one or more other devices at the property, data; determining whether an audio event likely occurred at the property using the obtained data; in response to determining that an audio event likely occurred at the property, determining, using the audio signal captured by the sound sensing device and event data for the audio event, whether a configuration of the sound sensing device is likely modified; and in response to determining that the configuration of the sound sensing device is likely modified, performing one or more actions for the modification of the configuration of the sound sensing device at the property.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, receiving the audio signal captured by the sound sensing device can include receiving, from the sound sensing device at the property, the audio signal that has a decibel level. Determining whether the configuration of the sound sensing device is likely modified can include: determining, using a type of the audio event, a decibel threshold for the type of the audio event; determining whether the decibel level satisfies the decibel threshold; and determining whether the configuration of the sound sensing device is likely modified using a result of the determination whether the decibel level satisfies the decibel threshold.

In some implementations, audio signal with the decibel level can be captured during a period of time during which the data was obtained.

In some implementations, the audio signal can have a plurality of decibel levels across a period of time during which it was captured. The method can include selecting, as the decibel level, a maximum decibel level from the plurality of decibel levels.

In some implementations, determining whether the configuration of the sound sensing device is likely modified can include: providing, to a calibration model configured to produce a likelihood that a respective audio signal matches to one or more calibrated audio signals for the sound sensing device, data representative of the audio signal; receiving, from the calibration model, an output that represents a likelihood that the received audio signal matches a calibrated audio signal; determining whether the likelihood satisfies a likelihood threshold; and in response to determining that the likelihood satisfies the likelihood threshold, determining that the sound sensing device is likely modified.

In some implementations, determining that the sound sensing device is likely modified can include: determining a difference between the received audio signal to the calibrated audio signal; and using the difference between the received audio signal and the calibrated audio signal, determining that the sound sensing device is likely modified.

In some implementations, the method can include: determining at least one of (i) a particular noise event from the obtained data or (ii) the device associated with the particular noise event; selecting, from a plurality of calibrated audio signals, the calibrated audio signal using at least one of the particular noise event or the device associated with the particular noise event; providing, to the calibration model, data for the calibrated audio signal.

In some implementations, determining, using the audio signal captured by the sound sensing device, whether a configuration of the sound sensing device is likely modified can include: determining whether a difference between at least a portion of the audio signal and an event audio signature for the audio event satisfies a difference threshold; and in response to determining that the difference does not satisfy the difference threshold, determining that the sound sensing devices is likely modified.

In some implementations, determining whether the configuration of the sound sensing device is likely modified can include at least one of determining whether the sound sensing device is encased, determining whether the sound sensing device has been tampered with, determining whether the sound sensing device has been relocated, or determining whether the sound sensing device has been turned off.

In some implementations, the method can include generating a calibrated model comprising training a machine learning model to calibrate to noises heard by the sound sensing device. The training can be performed by: receiving, while the sound sensing device is at a location at the property, audio signals encoding sound captured by the sound sensing device at the location at the property; labeling at least portions of the audio signals with identifiers that indicate devices that caused the noises at the property; and for each labeled identifier, providing data indicative of the portion of the audio signal and the label to the machine learning model to train the model to recognize the portion of the audio signal.

In some implementations, performing the one or more actions to for the modification of the configuration of the sound sensing device at the property can include: adjusting a weight for the sound sensing device; and determining whether to perform an action for the property using at least the audio signal, and the adjusted weight.

In some implementations, determining whether to perform an action for the property can use at least the audio signal, the adjusted weight, and additional sensor data captured by another sensor at the property.

In some implementations, determining whether the configuration of the sound sensing device is likely modified can include: monitoring, using noises captured by one or more sound sensing device at the property, an ambient noise of the property; determining whether the monitored ambient noise of the property satisfies an ambient noise threshold; and in response to determining that the monitored ambient noise of the property does not satisfy the ambient noise threshold, determining that the configuration of the sound sensing device is likely modified.

In some implementations, the method can include receiving, from the sound sensing device, temperature data for the sound sensing device that was captured while the sound sensing device was in use; and determining whether the temperature data satisfies a temperature threshold. Determining that the configuration of the sound sensing device is likely modified can be responsive to determining that the received temperature data does not satisfy the temperature threshold value.

In some implementations, the method can include receiving, from the sound sensing device, data indicative of a fan speed of a fan onboard the sound sensing device that was captured while the sound sensing device was in use; and determining whether the received data indicative of the fan speed satisfies a speed threshold. Determining that the configuration of the sound sensing device is likely modified can be responsive to determining that the received data indicative of the fan speed does not satisfy the speed threshold.

The subject matter described in this specification can be implemented in various implementations and may result in one or more of the following advantages. In some implementations, the systems and methods described in this specification can increase an accuracy of noise detection, e.g., by determining whether a configuration of a sound sensing device was likely modified. As a result of this determination, a system can perform an action that does not rely on data from the sound sensing device, an action to correct for the modification of the sound sensing device, or both, each of which can improve the system's accuracy in detecting noise, e.g., and corresponding events. This determination can reduce a likelihood that a system will perform an incorrect action given data from a sound sensing device that is a false positive or a false negative.

In some implementations, a system can dynamically adjust a weight of a model associated with a sound sensing device at a property when the sound sensing device is detected as being likely modified to reduce a likelihood of inaccurate analysis using sensor data from the sound sensing device. For instance, the system may determine that a sound sensing device has likely been tampered with or moved to an isolated location, such as moved to the closet. The system can assign a weight to the model of a respective sound sensing device. The weight can represent an accuracy of an output of the model for the respective sound sensing device. The output of the model can represent a likelihood that the input sound matches to a calibrated sound.

In response to detecting a sound sensing device being likely modified, a system can devalue a weight for the model of the likely modified sound sensing device and increase a weight for models of the sound sensing devices that have not likely been modified. In this manner, the model for the likely modified sound sensing device may be of relatively low importance. Similarly, the model of the sound sensing devices that have not been modified will be of higher importance, e.g., weighted higher. As such, the non-modified sound sensing devices can compensate for the likely modified sound sensing device reduction in accurate detections. Here, the system can focus on spending processing cycles, e.g., using computing resources, on non-modified sound sensing devices whose model outputs are more accurate than the models of the likely modified sound sensing device. Conversely, by not focusing on the models of the likely modified sound sensing devices, the system can reduce spending processing cycles on such models that may not produce accurate outputs, which wastes bandwidth and resources.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for monitoring a property to detect interface with sound sensing devices.

FIG. 2 is a flowchart of an example process for determining whether a sound sensing device was likely modified.

FIG. 3 is a diagram illustrating an example of a property monitoring system that may utilize various components to detect modification of sound sensing devices.

Like reference numbers and designations in the various drawings indicate like elements. The components shown here, their connections and relationships, and their functions, are meant to be examples only, and are not meant to limit the implementations described and/or claimed in this document.

### DETAILED DESCRIPTION

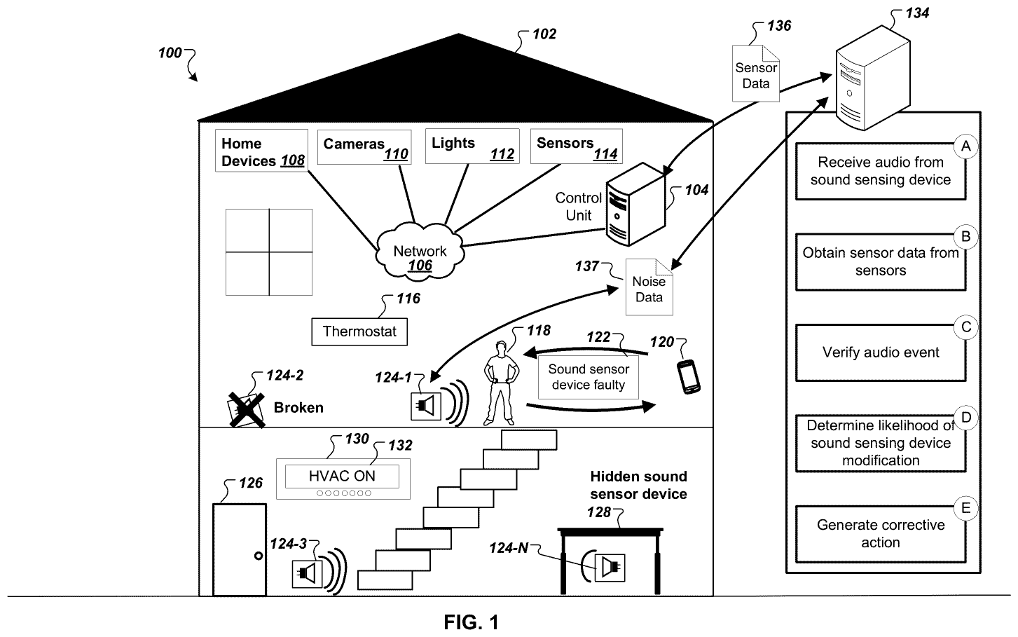

FIG. 1 is a block diagram of an example environment 100 for monitoring a property to detect interface with sound sensing devices. The environment 100 includes a monitored property 102 and one or more devices for monitoring the property 102. For example, the monitored property 102 can include a control unit 104, a network 106, one or more home devices 108, one or more cameras 110, one or more lights 112, one or more sensors 114, one or more sound sensing devices 124-1 through 124-N (hereinafter “sound sensing devices 124”), and a security panel 130. A subset of these components can be included in environment 100 or other components that fall within the scope of the present disclosure. The environment 100 can include a detection system 134 that communicates with devices internal to the monitored property 102 and with other monitored properties. In some implementations, the detection system 134 is physically located at the monitored property 102, e.g., and only analyzes data for the monitored property 102.

As shown in FIG. 1, the monitored property 102 is monitored by a control unit 104 that communicates with various components within the monitored property 102. The one or more home devices 108 may include appliances, such as a washing machine, a dryer, a dishwasher, an oven, a stove, a microwave, a thermostat 116, an HVAC, and other components found within a property, to name a few examples. The one or more cameras 110 may include video cameras that are located in the interior and exterior of the monitored property 102, such as near a front door 126 or outside the garage at the monitored property 102. The one or more sensors 114 can include motion sensors, contact sensors, lock sensors, pressure sensors, and other types of sensors. The one or more sensors 114 can monitor data from the doors, the windows, the garage door, the toilet, the bedroom, individuals and other components or locations within the monitored property 102.

The security panel 130 may include a device with a processor and a display screen that attaches or mounts to a surface. The security panel 130 can receive messages from the devices in the monitored property 102, the control unit 104, and a client device 120 connected to the network 106 and display the received messages on the display screen. In some cases, the security panel 130 can alert one or more individuals in the monitored property 102 through audible sounds, e.g., beeps, alarms, or other, and through visual display, e.g., display screen messages or alerts.

Each of the one or more drones may be docked at a charging station located at the monitored property 102. In some implementations, the control unit 104 can instruct a drone to depart from the docking station, to fly to a designated location or fly over a designated path at the monitored property 102, perform one or more actions, and return to the docking station. The devices in the monitored property 102 and the control unit 104 can monitor and detect the drone during the drone's navigation in the monitored property 102.

In some implementations, a sound sensing device 124 can include a device that monitors noise within a threshold distance of the device. In further detail, the sound sensing devices 124 can be configured to continuously monitor, record, or both, a decibel level over time. The sound sensing devices 124 can use any appropriate process, hardware, or combination of both, to monitor a decibel level. The sound sensing devices 124 can use the decibel level to determine a likelihood that an event that caused the sound is at a location that satisfies the threshold distance, e.g., is within or at or either, the threshold distance. In some examples, each sound sensing device can include a microphone for recording sounds within the threshold distance of the microphone. In some examples, each sound sensing device can include a camera that can record sound and capture imagery of a source of the recorded sound. The sound sensing device 124 can analyze the imagery to detect a likely sound.

In some implementations, the sound sensing devices 124 can transmit the recorded sound over the network 106. In some examples, the sound sensing devices 124 can receive a request from a device over network 106, e.g., a client device 120, a control unit 104, detection system 134, or other, for a recorded sound and respond to the request by transmitting the recorded sound or data about the recorded sound to the requesting device. In some examples, each time a sound sensing device 124 records a decibel level of a sound, the sound sensing device 124 can transmit the recorded sound to one or more devices over network 106. The sound sensing devices 124 can be configured to communicate with a single device or multiple devices.

Each sound sensing device can include one or more onboard sensors for monitoring a state of the sound sensing device. For example, each sound sensing device can include one or more temperature sensors, one or more motion sensors, one or more fans, and any other appropriate type of sensor. The sound sensing device can utilize data produced by the temperature sensors to represent a temperature state of the internal and/or external components of the sound sensing device. The sound sensing device can utilize data produced by the motion sensors to represent whether the sound sensing device is currently being moved or whether motion is detected proximate to the sound sensing device. The sound sensing device can utilize fan speed data, e.g., generated by a component of the fan such as a temperature sensor, to determine whether the sound sensing device is heating up, which would signal an increase in fan speed, cooling off, which would signal a decrease in fan speed, or if the sound sensing device is turning off or on, which would signal a sharp change in fan speed. The sound sensing device can provide the data from each of these sensors and other types of sensors over network 106 to one or more devices in the monitored property 102 upon request or at periodic intervals.

In some implementations, the sound sensing devices 124 can be placed at various locations throughout the monitored property 102. In some examples, sound sensing device 124-1 can be positioned on the floor of the second level of the monitored property and sound sensing device 124-2 can be positioned on the floor in the back of the room of the second level of the monitored property. In some examples, sound sensing devices 124-3 and 124-N can be placed at various locations on the bottom floor of the monitored property 102. The sound sensing devices 124 can be positioned in the monitored property 102 such that noise coverage is maximized throughout the entirety of the monitored property 102.

The environment 100 can generate a trained machine learning model for one or more, e.g., each, sound sensing device. The trained model can be for the location in the monitored property 102 at which the respective sound sensing device is located. The trained machine learning model can be configured to produce a confidence score, e.g., a likelihood, that a respective audio signal matches to one or more predetermined audio signals for a respective sound sensing device. In further detail, the detection system 134 can train a machine learning model to identify a likelihood that an audio signal captured by a respective sound sensing device satisfies a similarity threshold, e.g., matches, one of the predetermined audio signals for the respective sound sensing device. Here, the machine learning model can be trained using noises or sounds captured by a respective sound sensing device at its respective location in the monitored property 102, e.g., given the sounds the sound sensing device is likely to detect.

A sound sensing device can record audio signals at a set location in the monitored property 102 and the detection system 134 can train a machine learning model using the recorded audio signals recorded by a respective sound sensing device. For example, at a first location, the sound sensing device 124-3 may record audio of the security panel 130 creating a beep noise. For another sound sensing device 124 at a second location under the staircase or closer to sound sensing device 124-N, the other sound sensing device 124 may detect and record audio of the security panel 130 creating a beep noise differently than the sound sensing device 124-3 capturing the same beep noise at the first location. For example, the beep recorded by the sound sensing device 124-3 at the first location may have distinctive characteristics of the same beep recorded by the sound sensing device 124 at the second location. The characteristics may include a different magnitude, e.g., decibel level, a different duration, and a different shape of the recorded audio, for example. Thus, to train a machine learning model to accurately detect a recorded audio signal, the environment 100 can create calibrated audio signals as training data.

A calibrated audio signal can refer to a signal recorded by a sound sensing device at its designated location for which the corresponding machine learning model was trained. As part of the training process, or a calibration process, devices and components at the monitored property 102 can create noises and sounds for the sound sensing device to record at the respective location. In some examples, an HVAC system can turn ON or OFF, change another status, e.g., from circulating air to providing hear or AC, or a combination of these, so the sound sensing device can record the sound created by the HVAC system changing status. In some examples, a deadbolt can lock, unlock, or both, so the sound sensing device can record the sound created by the deadbolt unlocking or locking. Other examples are possible. For example, a security panel can create a beeping noise; a camera can generate a beeping noise; a vehicle traveling close to the proximity can create a noise; a doorbell can generate a chime noise; a garage door opening and closing creates a particular noise; a garbage disposal creates a particular noise; and a drone traversing the monitored property 102 creates a particular noise. Each of these noises can be captured by a sound sensing device at the respective location of the sound sensing device in the monitored property 102.

In some implementations, each of the sound sensing devices 124 can transmit their recorded audio signals or calibrated audio signals to the detection system 134. Here, the detection system 134 can train a machine learning model using the one or more audio signals for a respective sound sensing device. For example, the detection system 134 can receive three calibrated audio signals captured by sound sensing device 124-1. The three calibrated audio signals can include (i) a noise generated by an HVAC system, (ii) a noise generated by a deadbolt locking, and (iii) a noise generated by a drone traversing the monitored property 102. Other examples are possible. The detection system 134 can use the three calibrated audio signals to train a machine learning model for the sound sensing device 124-1.

In some examples, one or more of these signals can have a corresponding label, e.g., (i) “HVAC,” (ii) “Deadbolt lock”, and (iii) “Drone traversing”, respectively. The labels can be added as textual labels, binary data, visual images, or some other form of descriptive data. In some examples, the detection system 134 may automatically detect the type of device and the action of the device that created the noise using a classifier algorithm or some other type of detection algorithm. In some examples, the detection system 134 may receive input from a user that labels the type of device and the action of the device that created the noise. In response, the detection system 134 can label the recorded noise by adding attributes to the recorded sound's metadata, adding attributes to the recorded sound with a text file, or adding attributes to the recorded sound in other sounds. The detection system 134 can generate the labeled pairs and store the labeled pairs in memory in a local database or in a cloud, for later retrieval.

In response to labeling each of the recorded sounds, the detection system 134 can train the machine learning model using the labeled data and the recorded sounds. The detection system 134 can pair the respective attributes with the recorded sounds. The detection system 134 can provide each pair, e.g., labeled data plus the recorded sounds, as input to the machine learning model to train the machine learning model. The machine learning model can generate a confidence score, e.g., a likelihood, that the input matches to a respective calibrated sound.

This detection system 134 can iteratively train the machine learning model using any appropriate process. The detection system 134 can repeat this process iteratively for N number of recorded sounds and labeled pairs, a number of iterations for at least some of the pairs, or a combination of both, until the machine learning model for the respective sound sensing device is sufficiently trained. For example, in response to providing the calibrated sounds and labeled pairs to the machine learning model for a respective sound sensing device, the detection system 134 can provide a calibrated sound to the machine learning model without the labeled pair. The machine learning model can output a 95% confidence of “HVAC”, 10% confidence of “Deadbolt lock” and 5% confidence of “Drone traversing”, for example. If the detection system 134 determine that the calibrated sound was for an HVAC, the detection system 134 can determine to stop the iterative training process.

The detection system 134 can compare at least one of the output confidences to a threshold value and select the confidence that satisfies, e.g., meets or exceeds, the threshold. Here, the detection system 134 can select the 95% confidence of “HVAC” to determine whether this machine learning model generated an accurate output. If the generated output was correct and the detection system 134 determines the machine learning model produces accurate outputs for M number of inputs, the detection system 134 can determine the machine learning model is sufficiently trained. Although only three recorded sounds were used for example purposes above, the machine learning model for a particular sound sensing device may be trained using hundreds, thousands, or more of recorded sounds with labeled pairs. As will be further described below, the detection system 134 can use the output generated by the trained machine learning model to determine whether a configuration of the sound sensing device was likely modified.

One advantage of training the machine learning model can be to improve an accuracy of the sound sensing device given the location of the sound sensing device at the monitored property 102. As a result, when a property has multiple different calibrated sounds, for different devices, a sound sensing device can more accurately detect sounds from the devices that are most likely to generate noise captured by the sound sensing device compared to other systems, e.g., that might less accurately detect a wider variety of sounds.

In some implementations, the detection system 134 can store the trained machine learning models in memory using an index. For example, the detection system 134 can store the trained machine learning models in a local database, an external database connected over a network, or a cloud network. As mentioned, the detection system 134 trains a machine learning model to be calibrated for a particular sound sensing device at a designated location in the monitored property 102. For the detection system 134 to recall which trained machine learning model is calibrated for a particular sound sensing device, the detection system 134 can store a label identifying the sound sensing device with a particular trained machine learning model. The label can designate an identifier for the sound sensing device, which may include a name and location of the sound sensing device. In some examples, the label can include “Noise Sensor in basement by stairs” for sound sensing device 124-3. In some examples, the label can include “Noise sensor in middle of upper floor.” In some examples, the label can include a media access control (MAC) address, an internet protocol (IP) address, or some other address or identifier that identifies the sound sensing device. The detection system 134 can store the label in memory with the trained machine learning model. The detection system 134 can transmit the label to the corresponding sound sensing device, or another storage, for later retrieval and during application of one or more sound sensing devices 124.

In some implementations, the detection system 134 can store the calibrated sounds used to train the machine learning models with the respective machine learning models. For example, if the detection system 134 used 10,000 calibrated sounds to train a machine learning model for the sound sensing system 124-1, the detection system 134 can store the 10,000 calibrated sounds in memory with the label for the trained machine learning model, and the trained machine learning model itself. Each of the calibrated sounds can include metadata or attributes that describe characteristics of the calibrated sound. For example, the metadata or attributes can include a component in the property that made the sound, a length of the calibrated sound, a maximum dB level of the calibrated sound, a minimum dB of the calibrated sound, and other characteristics of the calibrated sound. The detection system 134 can utilize a length of the calibrated sounds to verify an audio event, as described in more detail below.

In some cases, a property owner may seek to limit the number of disruptions at their respective property, e.g., monitored property 102. Disruptions, such as noise disruptions, may lead to hefty fines for the property owner, a loss of reputation in their respective community, a poor experience for guests at the monitored property 102, and other potential damages caused to the property owner. In attempts to prevent such disruptions, the property owners can place the sound sensing devices 124 around the monitored property 102 to detect and mitigate these negative impacts of disruptions.

However, individuals at the monitored property 102 may adjust or tamper with the sound sensing devices 124 to avoid being flagged for disruptive noise violations, such as during a loud party or watching a movie with maximum volume. In these cases, users can, intentionally or unintentionally: unplug or destroy each of the sound sensing devices, tamper or damage the sound sensing devices to reduce the effectiveness of the sound sensing devices, e.g., remove the plastic shell of the sound sensing device and severs the connection of the microphone to the sound sensing device, encase each of the sound sensing devices to muffle or dampen the recording capability of the sound sensing device, and/or move the sound sensing device to an isolated part of the property, e.g., in a closet or in a trunk, for example. The following examples describes situations in which users may interfere with the sound sensing devices.

The techniques described in this specification can detect whether one or more sound sensing devices 124 have likely been modified, e.g., encased, tampered, or relocated in the monitored property 102. In further detail, the techniques described in this specification can address each of the example situations and other situations in which modification of a sound sensing device 124 has likely occurred. For example, the techniques can utilize one or more of the components within environment 100, including a trained machine learning model for the respective sound sensing device, the sensor data from any of multiple devices, and other components to determine whether a person likely interfered with the sound sensing device 124.

As illustrated in FIG. 1, during stage (A), the sound sensing device 124-1 can transmit noise data 137 to the detection system 134. The sound sensing device 124-1 can record a sound over a period of time from ambient noise recorded in the monitored property 102. The sound or audio signal can include, for example, ambient noise which reflects all noise present in a given environment. The ambient noise can encode, for example, individuals in the monitored property 102 communicating, music playing, noise made by one or more devices in the monitored property 102, water running, a fan blowing, or any other type of noise. The sound sensing device 124-1 can generate noise data 137 to include the recorded audio signal, data identifying the sound sensing device 124-1, or both. The data identifying the sound sensing device 124-1 can include, for example, an IP address, a MAC address, or some other identifier. In response to the generation, the sound sensing device 124-1 can transmit the noise data 137 to the detection system 134 over the network 106.

Each of the sound sensing devices 124 can record an audio signal and transmit a respective noise data to the detection system 134 over the network 106. In some implementations, a sound sensing device can transmit noise data to the detection system 134 when a noise level of the recorded audio data satisfies a threshold. For example, if sound sensing device 124-1 detects a noise that is above a predetermined decibel (dB) level, the sound sensing device 124-1 can record an audio signal encoding the noise for a period of time, and transmit noise data to the detection system 134.

Noise may occur in a monitored property 102 at periodic and non-periodic intervals. Noise generated on periodic intervals can include, for example, an HVAC changing state and blowing air through the vents of the monitored property 102, the lights turning ON and OFF, a deadbolt unlocking in the morning at the same time each day, and other events. Noise generated on non-periodic intervals can include, for example, individual speaking in the house, music being played, toilet flushing, garage door activity, garbage disposal activity, and other events. The environment 100 can analyze the periodic and non-periodic noise accordingly to determine whether a corresponding sound sensing device has been likely modified as described in more detail below.

During stage (B), the thermostat 116 can transmit sensor data 136 to the detection system 134 over the network 106. The sensor data 136 can include, for example, data indicating that the HVAC system turned on at 7:00 AM ET, the current temperature was set to 67 F, and the desired temperature at 7:00 AM ET was 69 F. In some cases, the control unit 104 may obtain sensor data 136 from a subset of, e.g., each of, the devices in the monitored property 102 and transmit the sensor data 136 to the detection system 134. The detection system 134 can receive the sensor data 136 from the control unit 104 and/or the devices in the monitored property 102.

For instance, the noise generated by one device periodically can be independently verified by other devices in the monitored property. In this manner, a device in the monitored property can determine when a second device in the monitored property has activated. For example, the thermostat 116 can determine a time when the HVAC system has been turned ON, and this time can be signaled to the detection system 134. The thermostat 116 may be set to run on a periodic interval, e.g., set to 69 Fahrenheit (F) at 7:00 AM ET, and set to 68 F at 6:00 PM ET. Thus, when the thermostat sets the temperature of the monitored property 102 to 69 F, the HVAC system turns on, or begins generating heat, to move air through the monitored property to move the current temperature of the property to 69 F. When the HVAC system turns on, the HVAC generates a noise that can be detected by one or more of the sound sensing devices 124 in the monitored property 102.

During stage (C), the detection system 134 can analyze the received sensor data 136 to verify an audio event at the monitored property 102, e.g., determine whether an audio event occurred at the monitored property. For instance, the detection system 134 can extract data from the received sensor data 136 to determine whether an audio event likely occurred. The audio event can be an event for which the machine learning model for the sound sensing device 124-a was trained. In some examples, the detection system 134 can extract data from the sensor data 136 associated with each of a subset of the devices over a prior time period, and use the data from the subset of devices to verify the audio event.

For example, the detection system 134 can extract data associated with the thermostat from the sensor data 136 indicating that the HVAC system turned on at 7:00 AM ET, the current temperature of the monitored property was set to 67 F, and the desired temperature at 7:00 AM ET was 69 F. The detection system 134 can utilize one or more data processing algorithms to analyze the text from the extracted data of the sensor data 136 to determine that an audio event has in fact occurred, according to the thermostat 116. The text from the extracted sensor data can include, for example, that the HVAC system was to turn ON at 7:00 AM ET. The detection system 134 can use this “ON” data to determine that the HVAC system would likely generate noise around 7:00 AM.

In some implementations, the detection system 134 can identify one or more calibrated sounds associated with the sound sensing device that transmitted the noise data 137. The noise data 137 includes an identifier or label for the sound sensing device that transmitted the noise data 137. The detection system 134 can identify data for the sound sensing device using the identifier, e.g., a MAC address, an IP address, or other, as an index. The detection system 134 can identify, as the data, multiple calibrated sounds for which a machine learning model for the sound sensing device 124-1 was trained. These calibrated sounds can be sounds that the sound sensing device 124-1 is likely to detect.

The detection system 134 can verify the audio event by determining that the sensor data 136 indicates that a sound likely occurred at the monitored property 102. In some examples, the detection system can verify that an audio event for which the machine learning model for the sound sensing device 124-1 was trained likely occurred. In some examples, the detection system 134 can verify only audio events for which the sound sensing device 124-1 likely captured audio data, e.g., that were generated within a threshold distance of the sound sensing device, had a decibel level that satisfies a decibel threshold, or a combination of both.

In some examples, if the detection system 134 determines that the audio event is not verified, the detection system 134 can determine to skip analysis of the noise data 137. This can reduce computational resource usage that would otherwise be spent analyzing the noise data 137 for an audio event that has not occurred, reduce a likelihood of false alarms, or both.

In some implementations, the noise generated by non-periodic events might not be verified by other devices in the monitored property 102. For example, a speaker blaring music or an HVAC system turning ON manually by a user can be a non-periodic event that is detected and recorded by one or more sound sensing devices 124 at the monitored property 102. The noises caused by non-periodic events, e.g., toilet flush, HVAC system, garage door opening, and other, can occur at any time at the monitored property 102 and can be detected and recorded by one or more sound sensing devices 124 at the monitored property 102. In response to one or more of the sound sensing devices 124 detecting a noise that is non-periodic, the one or more sound sensing devices 124 can transmit the recorded noise over the network 106 to the detection system 134. This process for recording noises of non-periodic events can include functions similarly described in stages (A) through (C).

If the detection system 134 determines that the audio event is verified, during stage (D), the detection system 134 can determine a likelihood that the sound sensing device 124-1 has been modified. For instance, the detection system 134 can determine the likelihood by comparing a first subset of the noise data 137 and a calibrated sound for the device that generated the sound to determine the likelihood. In some examples, the detection system 134 can provide the noise data 137 to a machine learning model that generates an output that indicates the likelihood.

The detection system 134 can utilize the text for the sensor data 136, e.g., a label for the sensor data 136, to identify, from multiple calibrated sounds that the sound sensing device is likely to detect, a calibrated sound for the particular sound sensing device 124-1. The text from the sensor data 136 can include a description of the devices that generated the sound, such as “HVAC” and “thermostat”, for example. The detection system 134 can provide the description as input to a machine learning model along with at least a portion of the noise data 137. In response, the detection system 134 can receive, from the machine learning model, output that indicates the likelihood.

In some examples, the detection system 134 can identify a calibrated sound stored in memory that is associated with the identifier for the sound sensing device 124-1 and the description of the generating device. In further detail, the detection system 134 can access metadata of each calibrated sound stored with the identifier to determine a calibrated sound that includes a description of a component in the property that made a sound that matches to the description of the devices involved in the sensor data 136. For example, the detection system 134 can identify a calibrated sound that includes the metadata of “HVAC”, e.g., describing the device that created the corresponding calibrated sound, using the text description of “HVAC” from the sensor data 136. In some examples, the detection system 134 can determine a calibrated sound in a database of calibrated sounds, e.g., that is not necessarily associated with the identifier of the sound sensing device 124-1.

In response, the detection system 134 can compare at least a portion of the received noise data 137 with the calibrated sound for the sound generating device to determine whether the two satisfy a similarity criterion, e.g., using any appropriate process. For instance, the detection system 134 can determine whether the calibrated sound for the HVAC matches the noise data 137 captured by the sound generating device 124-1 when the HVAC system generated a noise, e.g., the audio event, at 7:00 AM ET to turn ON. The detection system 134 can perform a correlation with the time identified from the extracted sensor data to identify a noise at a similar time, e.g., within a threshold time period, in the received noise data 137. In further detail, the detection system 134 can select a subset of the audio signals in the received noise data 137 starting at a time indicated by the time identified from the extracted sensor data, e.g., 7:00 AM ET, and lasting for a predetermined amount of time.

The detection system 134 can determine the predetermined amount of time using any appropriate process, e.g., according to a length of time of the identified calibrated sound of the similar type. In some examples, a calibrated sound for an HVAC system turning ON at the monitored property 102 can have an average duration for the HVAC system turning ON, for HVAC systems generally turning ON, or a combination of both.

The detection system 134 can select the subset of the audio signal in the received noise data 137 starting at the time indicated by the time identified from the extracted sensor data, e.g., 7:00 AM ET. The selected subset of the audio signal can have around the same duration as the predetermined amount of time. For instance, the selected subset can have the same duration or a duration within a threshold duration of the predetermined amount of time. In some examples, the samples of noise in the audio signal can be indexed by time, enabling the detection system 134 to extract the subset of the audio signal from the received noise data 137 according to the time identified from the extracted sensor data. In the event that the detection system 134 determines that the length of the audio signal is less than the predetermined length of the candidate signal, the detection system 134 can select the entirety of the audio signal in the received noise data 137.

The detection system 134 can determine a difference between the audio signal and the calibrated sound. For instance, any change in a configuration of the sound sensing device or obstruction of the sound sensing device can affect how the sound sensing device captures an audio signal of the sound generated by a device, e.g., the HVAC. This change can be reflected in larger difference between the audio signal and the calibrated sound than if no change had occurred, e.g., given that different recordings of the same sound are sometimes encoded differently. The detection system 134 can use any appropriate process to determine the difference between the extracted audio signal and the calibrated sound signal. The difference can be any appropriate value, e.g., a difference score or other data that represents the difference. The detection system 134 can compare the difference to a first threshold value. If the detection system 134 determines that the difference satisfies, e.g., meets or exceeds or either, the first threshold value, the detection system 134 can determine the audio event, e.g., HVAC system turning ON, the sound sensing device 124-1 likely is not modified.

In the case the detection system 134 determines the sound sensing device is likely not modified, the detection system 134 can store, in memory, the recorded audio from the noise data 137 as an additional calibrated noise for future training of the respective machine learning model. In this manner, the detection system 134 can store additional training data for retraining the training model.

If the detection system 134 determines the similarity score does not satisfy the first threshold value, the detection system 134 can determine the sound sensing device is likely modified. The detection system 134 can take corrective actions in determining the sound sensing device is likely modified. For instance, the detection system 134 can notify a property owner 118 via an alert on the display 132 of the security panel 130, send an alarm to client device 120 of the property owner 118, or both. In some examples, the detection system 134 can designate that an issue exists with the sound sensing device 124-1, the device that created the audio event, e.g., when that device is not properly generating sounds that can be used for analysis, or both.

In further detail, the detection system 134 can receive the noise data 137 from a sound sensing device, such as the sound sensing device 124-1. The detection system 134 can extract an identifier from the noise data 137 to identify the sound sensing device that transmitted noise data 137. The detection system 134 can select a calibration model, e.g., trained machine learning model, indexed by the identified sound sensing device, e.g., sound sensing device 124-1. The calibration model can be calibrated utilizing the calibrated sounds, e.g., noises recorded by the sound sensing device 124-1 at the sound sensing device's 124-1 designated location in the monitored property 102.

In some implementations, the detection system 134 can provide data representative of the audio signal in the received noise data 137 to the identified calibration model. The data representative of the audio signal can include, for example, a digital representation of the audio signal in the time domain, a digital representation of the audio signal in the frequency domain, and other types of digital representations, to name a few examples. The detection system 134 can provide the data representative of the audio signal to the identified calibration model to cause the calibration model to produce an output.

In some examples, the output of the identified calibration model can include one or more likelihoods that the received audio signal matches to the one or more calibrated sounds for the sound sensing device 124-a, and optionally a label for each of the one or more likelihoods. In particular, the detection system 134 trained the identified calibration model on the one or more calibrated sounds and paired labeled data. Accordingly, the identified calibration model can receive the input audio signal and output the labels and the one or more likelihoods that the input audio signal matches to the one or more calibrated sounds. In some examples, the calibration model outputs a vector of likelihoods and a location in the vector indicates the corresponding label. The detection system 134 can maintain data in memory that indicates the labels for the corresponding vector locations.

For example, the received audio signal can include a noise that a garage door opens recorded by sound sensing device 124-1. The detection system 134 can select the identified calibration model for the sound sensing device 124-1 and provide the received audio signal to the identified calibration model. The identified calibration model can be calibrated or trained on three calibrated sounds-one calibrated sound of an HVAC sound, one calibrated sound of a beeping noise by the security panel 130, and one calibrated sound of a garbage disposal. In response to processing the received audio signal, the identified calibration model can output a likelihood of 85% for the calibrated sound of an HVAC sound, a likelihood of 15% for the calibrated sound of the beeping noise by the security panel 130, and a likelihood of 10% for the calibrated sound of the garbage disposal.

In response, the detection system 134 can compare at least some, e.g., each, of the one or more likelihoods to a threshold value. For instance, the detection system 134 can detect whether a particular likelihood that satisfies, e.g., exceeds or meets, the threshold value. The particular likelihood detected can be the particular likelihood that satisfies the threshold value and indicates a higher likelihood than the other likelihoods output by the identified calibrated model. If none of the likelihoods output by the identified calibrated model satisfies the threshold value, the detection system 134 can determine that the sound sensing device 124-N is likely modified. In response, the detection system 134 can proceed to stage (E) to generate one or more corrective actions.

In some implementations, the detection system 134 determining a sound sensing device is likely modified indicates the sound sensing device has been modified in one or more of the following ways. In some examples, the detection system 134 may determine the sound sensing device has been moved to a location other than the location where the sound sensing device was calibrated. In some examples, the detection system 134 may determine the sound sensing device has been encased by one or components in the monitored property 102, e.g., a table, a towel, a blanket, or either. In some examples, the detection system 134 may determine the sound sensing device has been tampered or destroyed.

In some implementations, the detection system 134 can determine a modification type that likely occurred. The detection system 134 can use any appropriate type of data, analysis, or both, to determine the likely modification type. For instance, the detection system 134 can use image data from a camera that typically has a line of sight of a physical location of a sound sensing device. If the sound sensing device is not depicted in any images captured by the camera, e.g., when a field of view of the camera includes the physical location, the detection system 134 can determine that the sound sensing device was likely relocated. In some examples, the detection system 134 can use image data from cameras that do not typically include a line of sight to the default physical location of the sound sensing device but gain a line of sight after a modification, e.g., after the sound sensing device was moved.

The detection system 134 can use a wireless signal strength to determine a likely modification type. For instance, the detection system 134 can use a local area network (“LAN”), e.g., Z-Wave or Wi-Fi™, signal strength of a sound sensing device to determine whether the sound sensing device was likely moved. Since walls and other types of barriers can affect radio frequency communication, a change in the signal strength between the sound sensing device and another device 108 at the property 102, e.g., a wireless router, can indicate that the sound sensing device was likely moved to another room from an original room in which the sound sensing device was located.

The detection system 134 can use temperature data to determine a likely modification type. For example, when a sound sensing device includes a temperature sensor, cooling mechanism, or another component or process by which to infer its temperature, e.g., given the internal circuitry of the sound sensing device, the detection system 134 can use temperature data from the sound sensing device to determine whether or not the sound sensing device was related or encased, e.g., in a blanket. When a change in the temperature of the sound sensing device from a baseline temperature satisfies a first threshold, the detection system 134 can determine that the sound sensing device was likely encased, e.g., indicating that the device is cooling less efficiently. When a change in the temperature of the sound sensing device from a baseline temperature satisfies a second threshold, e.g., and the first threshold, the detection system 134 can determine that the sound sensing device was likely moved. This can occur when there is a larger temperature change, e.g., from an ambient indoor or location temperature, indicating a likely relocation of the sound sensing device from a default location at the property 102 to a basement, garage, or another area of the property 102 that is not climate controlled in the same way as the default location.

In some implementations, the detection system 134 can use data from an audio signal to determine a likely modification type. For instance, during a testing phase, the machine learning model, or another appropriate component or process, can be trained to detect a likely modification type. A training system can provide the machine learning model with a sound frequency captured by a sound sensing device, along with a label that indicates the corresponding modification type. In these implementations, the machine learning model is trained to detect modification types and modification events. The machine learning model can include multiple outputs. A first subset of the outputs can indicate whether a modification event likely occurred. A second subset of the outputs can indicate a likely modification type. In some examples, a single output can indicate both whether a modification event likely occurred and a likely modification event, e.g., when the output is an array and a value for an entry in the array corresponds to a likelihood that a respective modification type occurred. In some examples, during runtime, the detection system 134 can receive feedback indicating a modification type and can train the machine learning model further using the feedback. This can improve the performance of the machine learning model for the property 102, e.g., given the unique context of the property 102 and where the sound sensing device is positioned at the property.

During stage (E), the detection system 134 can generate one or more corrective actions to mitigate or correct the modification of configuration of the sound sensing device at the property. In some examples, the detection system 134 can transmit an alert to client device 120 of the property owner 118 to indicate the sound sensing device is likely modified. The alert can include, for example, a message indicating that an identifier for the sound sensing device is likely modified. The alert can be transmitted by, for example, text, email, or phone call, to name a few examples. In some examples, the detection system 134 can transmit the alert to the security panel 130 for display on the display 132. The security panel 130 can display the alert on the display 132 and provide an audible noise, e.g., a beep, for the owners in the monitored property 102.

In some implementations, the property owner 118 can view the alert on the client device 120 or the security panel 130 and take action. The property owner 118 can determine that an alert exists with sound sensing device 124-N and proceed to view the sound sensing device 124-N. In some examples, as illustrated in environment 100, the property owner 118 can determine that sound sensing device 124-N is encased by a table 128, muffling the noise recorded by the sound sensing device 124-N. In some examples, as illustrated in environment 100, the property owner 118 can determine that sound sensing device 124-2 has been tampered with and/or destroyed, which is the reason why the detection system 134 cannot communicate with the sound sensing device 124-2.

In response to detecting an issue with a sound sensing device, the property owner 118 or other individual can proceed to address the issue with each of the sound sensing devices that have been likely modified. In some examples, the property owner 118 can remove the sound sensing device 124-N from underneath the table 128. In some examples, the property owner 118 can replace the broken sound sensing device 124-2 with other sound sensing devices that works properly. In some examples, the property owner can relocate a sound sensing device that has been placed in an isolated location, such as the move, to a location in the middle of the first floor. Other examples are possible.

In some implementations, the detection system 134 can dynamically adjust a weight for a model, e.g., a calibration model or an on device model used to detect sounds, when the sound sensing device associated with the calibration model has been likely modified. For example, the detection system 134 may assign a weight to each of the models, e.g., when each model is for a different sound sensing device 124 at the monitored property 102. The weight can represent an accuracy of an output of the model for the respective sound sensing device. For example, initially, the detection system 134 may assign a weight of 100% to each of the models. In response to the detection system 134 determining a sound sensing device has been modified, the detection system 134 can adjust, e.g., depreciate, the weight for the corresponding model, adjust, e.g., increase, the weights for the other models, or a combination of both.

In this manner, the server system can weight the output of any model whose sound sensing device has been likely modified to be of lower importance than the other models. Similarly, the output of the models whose sound sensing devices have not been modified can be weighted with higher values compared to other models. The models of the non-modified sound sensing devices can compensate for the model of the modified sound sensing device whose detections is now likely to be less accurate. In response to reducing the weight for the model of the modified sound sensing device and increasing the weight of models of non-modified sound sensing devices, the detection system 134 can process the models' outputs using the updated weights and perform actions for the monitored property 102 using the weighted outputs.

For example, if the detection system 134 determines sound sensing device 124-N and sound sensing device 124-2 were determined to be likely modified, the detection system 134 can reduce the weight of their models to a lower value, e.g., 30%. Conversely, the detection system 134 can increase the weight of the models of sound sensing device 124-1 and 124-3 to a higher value, e.g., 150%. Thus, if the HVAC turns on in a non-periodic fashion at the monitored property 102 and each of the sound sensing devices 124 recorded the noise of the HVAC system turning ON, each of the sound sensing devices 124 can transmit their respective noise data 137 to the detection system 134. The detection system 134 can identify the respective models for each of the sound sensing devices 124 and provide the recorded audio signals from the respective noise data 137 to the respective models. In this example, the weights of the models for the modified sound sensing device 124-2 and sound sensing device 124-N have been reduced to 30%. Generally, a reduction in weight for a model of a sound sensing device reduces the overall importance of output from that respective model. An increase in weight for a model of a sound sensing device increases the overall important of output for that respective model.

In this example, if the models for the unmodified sound sensing devices 124-1 and 124-3 indicate that the detected sound was likely the HVAC while the models for the modified sound sensing devices 124-2 and 124-N indicate that the detected sound was likely a fan. When determining whether to perform an action, or an action to perform, given the detected sound, the detection system 134 can combine the outputs from the models for the various sound sensing devices 124. For instance, the detection system 134 can discard outputs from models with weights that do not satisfy a threshold value, or combine the likelihoods using the respective weights. The detection system 134 can use outputs from models for which the weights satisfy the threshold value, or combine the likelihoods using the respective weights.

In some implementations, the detection system 134 can execute calibration testing in response to receiving data indicative of an activity in the monitored property 102. The detection system 134 can execute calibration testing to determine if one of the sound sensing devices 124 has been likely modified. In some implementations, the detection system 134 can proactively conduct calibration tests to whether one of the sound sensing devices 124 have been likely modified. The detection system 134 can perform one or more calibration tests to analyze a configuration of the one or more sound sensing devices 124.

In some implementations, the detection system 134 can determine appropriate times for executing a calibration test. In further detail, the detection system 134 can compare a level of the ambient noise in the monitored property 102 to a threshold to determine whether it is appropriate to execute a calibration test. For example, the detection system 134 may request for sensor data from the home devices 108, the cameras 110, and the sensors 114. The detection system 134 can receive the sensor data and determine from the sensor data that the ambient noise in the monitored property 102 that does not satisfy, e.g., is greater than, a threshold value, indicating a period of high activity in the monitored property 102. The ambient noise in the monitored property 102 being not satisfying the threshold value indicates that a calibration test would be rendered ineffective. The detection system 134 can determine to skip calibrating a sound sensing device when the threshold value is not satisfied. When the threshold value is satisfied, and a calibration process is more likely to be accurate, the detection system 134 can perform a calibration test, since the sensor data indicates that a calibration test would not likely be rendered ineffective, such as when the monitored property 102 is vacant.

In some implementations, a change in ambient noise can represent a likelihood that a sound sensing device has been modified. For instance, a sound sensing device 124-1 can detect audio with a level of ambient noise. When the level of ambient noise satisfies an ambient level threshold, e.g., determined for that sound sending device given sounds detected by the sound sensing device at least a threshold amount of time, the detection system 134 can determine that the sound sensing device likely has not been modified. When the level of ambient noise does not satisfy the ambient level threshold, the detection system 134 can determine that the sound sensing device has likely been modified.

In some implementations, the detection system 134 can generate an alert to the user or conduct a calibration test to verify if a sound sensing device is likely modified if a change in temperature of the air, electronics, or both, inside the sound sensing device satisfies a change criterion, e.g., suddenly changes or changes by a threshold amount. For example, each of the sound sensing devices 124 can include one or more temperature sensors and one or more fans. The temperature sensors can be used to monitor a temperature inside each of the sound sensing devices 124. The fans can report their speeds, which can indicate whether the temperature inside each of the sound sensing devices 124 is increasing or decreasing.

In some examples, a sound sensing device 124-N can determine the temperature of the components internal to the sound sensing device 124-N satisfies a threshold value. In this case, the sound sensing device 124-N can transmit an alert to the detection system 134 to indicate that encasement of the sound sensing device 124-N is likely. In some examples, if the sound sensing device 124-N determines the temperature of the sound sensing device 124-N's internal components changes at a rate greater than a threshold rate, the sound sensing device 124-N can transmit an alert to the detection system 134 to indicate that encasement of the sound sensing device 124-N is likely.

A sound sensing device 124-3 can determine a fan speed of a fan internal to the sound sensing device. If the sound sensing device 124-3 determines the fan speed satisfies a threshold speed or changes at a rate that satisfies a threshold rate, the sound sensing device 124-3 can an alert to the detection system 134 to indicate that encasement of the sound sensing device 124-3 is likely. In response, the detection system 134 can conduct a calibration test to verify if the sound sensing device 124-3 is likely modified or generate an alert to the user.

In some examples, one or more sound sensing devices 124 may be located outside a building at the monitored property 102 and can be calibrated using outdoor noise events, e.g., weather events, vehicles passing, or other types of outdoor events. The outdoor noise events can be verified by the microphone or the one or more sound sensing devices 124. Cars can drive by the monitored property 102 and create loud noise, and an outdoor camera can use analytics to timestamp when the vehicle drives by the monitored property 102. In some examples, the outdoor cameras can generate sounds, e.g., beeping sounds, similar to the security panel 130 generating the beeping sequence, which sounds can be captured by a sound sensing device 124 other than the camera. In some examples, the opening and closing of a garage door can generate a loud outdoor noise event, which can be verified by an outdoor camera or a microphone. In these cases, the outdoor camera can verify the outdoor noise events.

In some examples, doorbell chimes can be verified by a doorbell camera. Doorbell chimes can generate a loud noise that can be recorded from outside the monitored property 102 and inside the monitored property 102. In some examples, a garbage disposal can be verified by a smart switch, such as the smart switch used to open and close the garbage disposal.

In some examples, the one or more sound sensing devices 124 can generate sensor data that indicates a detection of ongoing fire inside the monitored property 102, outside the property 102, or a combination of both. The one or more sound sensing device 124 can provide the generated sensor data to the detection system 134. The detection system 134 can use the generated sensor data to verify the audio event, e.g., determine that fire is heard at the monitored property 102, and to determine whether the one or more sound sensing devices 124 are properly working.

In some examples, a drone can be programmed to navigate the interior or exterior of a monitored property 102. As drone traverses the monitored property 102, the drone can be configured to generate an audible sound at specified locations or in a continuous manner to calibrate the sound sensing devices 124. Indoor and outdoor cameras and microphones can verify the audible sounds generated by the drone. By relying on a drone that navigates the monitored property 102, a drone can aid in the process of calibrating each of the sound sensing devices 124 in the monitored property 102.

Although the examples above describe the detection system 134 as performing various operations, a sound sensing device 124 can perform one or more, or even all, of these operations. For instance, a sound sending device 124 can use a model to detect sounds, optionally a type of the sound, to trigger an action. In some examples, a sound sending device 124 can use a calibration model to determine whether the sound sensing device was likely modified.

The detection system 134 is an example of a system implemented as computer programs on one or more computers in one or more locations, in which the systems, components, and techniques described in this specification are implemented. The home devices 108, the client devices 120, or both, can include personal computers, mobile communication devices, and other devices that can send and receive data over the network 106. The network (not shown), such as a local area network (“LAN”), wide area network (“WAN”), the Internet, or a combination thereof, connects the home devices 108, the cameras 110, the lights 112, the sensors 114, the sound sensing devices 124, client device 120, and to other devices at the monitored property 102, and the detection system 134. The detection system 134 can use a single server computer or multiple server computers operating in conjunction with one another, including, for example, a set of remote computers deployed as a cloud computing service.

The detection system 134 can include several different functional components. The detection system 134, the components in the detection system 134, or a combination of these, can include one or more data processing apparatuses, can be implemented in code, or a combination of both. For instance, the detection system 134 can include one or more data processors and instructions that cause the one or more data processors to perform the operations discussed herein.

The various functional components of the detection system 134 can be installed on one or more computers as separate functional components or as different modules of a same functional component. For example, the components of the detection system 134 can be implemented as computer programs installed on one or more computers in one or more locations that are coupled to each through a network. In cloud-based systems for example, these components can be implemented by individual computing nodes of a distributed computing system.

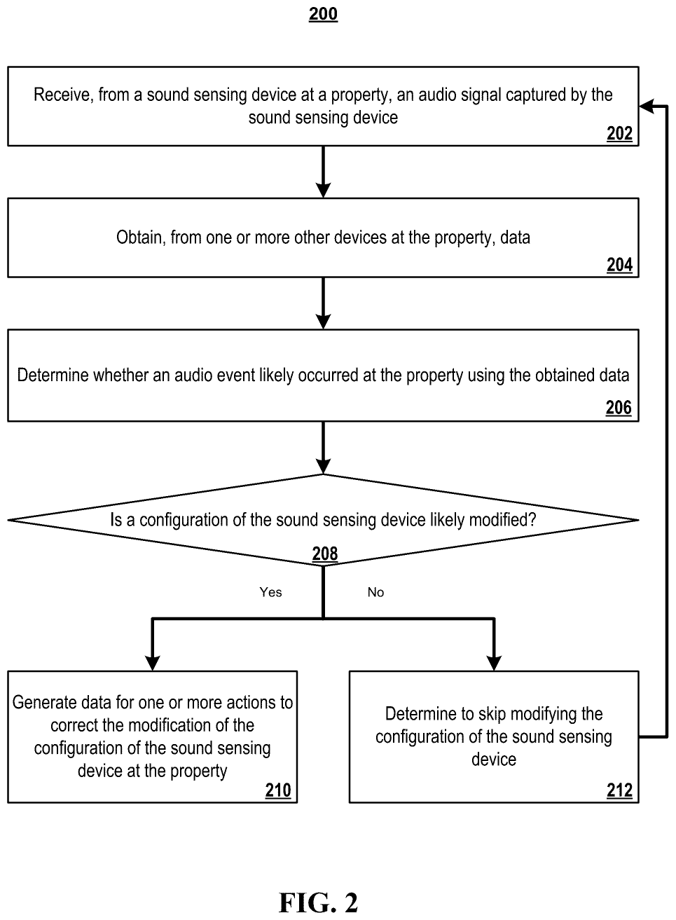

FIG. 2 is a flowchart of an example process 200 for determining whether a sound sensing device was likely modified. The detection system 134 can perform the process 200 from the environment 100, for example.

The system can receive, from a sound sensing device at a property, an audio signal captured by the sound sensing device (202). For instance, the sound sensing device can captured the audio signal, e.g., using a microphone. The system can receive the audio signal after the microphone stops capturing the audio signal, or at least partially concurrently with capture of the audio signal.

The system can obtain, from one or more other devices at the property, data (204). For instance, the system can obtain the data over a period of time. The data can be any appropriate type of data, such as that described in more detail above.

The system can determine whether an audio event likely occurred at the property using the obtained data (206). This can be part of an audio event verification process. If the system determines that the audio event likely did not occur, the system can determine that the sound sensing device was likely modified, e.g., when the audio signal indicates that an audio event likely occurred. In these examples, the system can perform operation 210. If the system determines that the audio event likely did not occur, the system can determine to stop performing operations in the process 200, e.g., when the audio signal does not indicate that an event likely occurred. For instance, the system can analyze the audio signal to determine whether the audio signal indicates that an event likely occurred. In implementations in which the sound sensing device determines whether an audio event likely occurred and the obtained data does not, the system can determine that the sound sensing device is likely modified.

The system can determine whether a configuration of the sound sensing device is likely modified (208). The system can perform this determination in response to determining that an audio event likely occurred.

In response to determining the configuration of the sound sensing device is likely modified, the system can generate data for one or more actions to correct the modification of the configuration of the sound sensing device at the property (210). The actions can be any appropriate action, such as those described above.

In response to determining the configuration of the sound sensing device is not likely modified, the system can determine to skip modifying the configuration of the sound sensing device at the property (210). For instance, the system can stop performing operations in the process 200.

The order of operations in the process 200 described above is illustrative only, and determining whether the sound sensing device was likely modified can be performed in different orders. For example, the system can obtain the data and then receive the audio signal. In some examples, the system can, in response to determining that an audio event likely occurred, request the audio signal from the sound sensing device. In response, the system can receive the audio signal.

In some implementations, the process 200 can include additional operations, fewer operations, or some of the operations can be divided into multiple operations. For example, the process can include operations 202 through 210 without operation 212. The process can include operations 202 through 208 and 212, without operation 210. In some implementations, the process does not include operations 204 or 206, e.g., when the system uses an ambient noise threshold for the audio signal. These implementations can include either operation 210, or operation 212.

In some implementations, the system can receive other types of data from the sound sensing device. For instance, the system can receive temperature data, fan speed data, or both, for the sound sensing device. The system can process this data to determine whether a configuration of the sound sensing device was likely modified.

For situations in which the systems discussed here collect personal information about people, or may make use of personal information, the people may be provided with an opportunity to control whether programs or features collect personal information (e.g., sounds generated by activity by the person). In addition, certain data may be anonymized in one or more ways before it is stored or used, so that personally identifiable information is removed. For example, a person's identity, e.g., voice, may be anonymized so that no personally identifiable information can be determined for the person. Thus, the people may have control over how information is collected about him or her and used.

In this specification the term “engine” refers broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

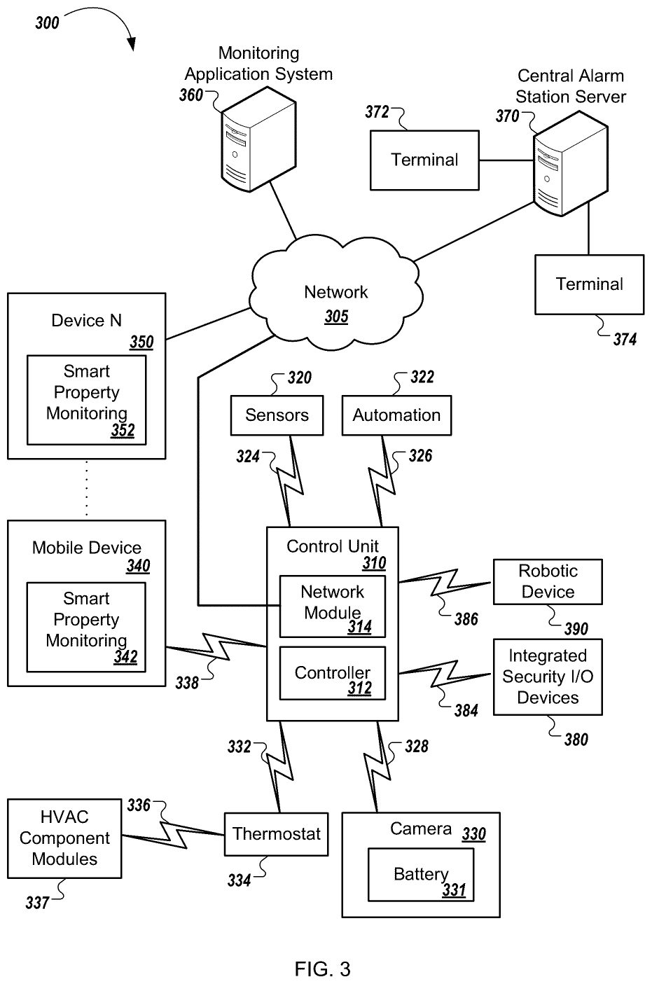

FIG. 3 is a diagram illustrating an example of an environment 300, e.g., for monitoring a property. The property can be any appropriate type of property, such as a home, a business, or a combination of both. The environment 300 includes a network 305, a control unit 310, one or more devices 340 and 350, a monitoring system 360, a central alarm station server 370, or a combination of two or more of these. In some examples, the network 305 facilitates communications between two or more of the control unit 310, the one or more devices 340 and 350, the monitoring system 360, and the central alarm station server 370.

The network 305 is configured to enable exchange of electronic communications between devices connected to the network 305. For example, the network 305 can be configured to enable exchange of electronic communications between the control unit 310, the one or more devices 340 and 350, the monitoring system 360, and the central alarm station server 370. The network 305 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 305 can include multiple networks or subnetworks, each of which can include, for example, a wired or wireless data pathway. The network 305 can include a circuit-switched network, a packet-switched data network, or any other network able to carry electronic communications (e.g., data or voice communications). For example, the network 305 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VoIP”), or other comparable protocols used for voice communications. The network 305 can include one or more networks that include wireless data channels and wireless voice channels. The network 305 can be a broadband network.

The control unit 310 includes a controller 312 and a network module 314. The controller 312 is configured to control a control unit monitoring system, e.g., a control unit system, that includes the control unit 310. In some examples, the controller 312 can include one or more processors or other control circuitry configured to execute instructions of a program that controls operation of a control unit system. In these examples, the controller 312 can be configured to receive input from sensors, or other devices included in the control unit system and control operations of devices at the property, e.g., speakers, displays, lights, doors, other appropriate devices, or a combination of these. For example, the controller 312 can be configured to control operation of the network module 314 included in the control unit 310.

The network module 314 is a communication device configured to exchange communications over the network 305. The network module 314 can be a wireless communication module configured to exchange wireless, wired, or a combination of both, communications over the network 305. For example, the network module 314 can be a wireless communication device configured to exchange communications over a wireless data channel and a wireless voice channel. In some examples, the network module 314 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 314 can be a wired communication module configured to exchange communications over the network 305 using a wired connection. For instance, the network module 314 can be a modem, a network interface card, or another type of network interface device. The network module 314 can be an Ethernet network card configured to enable the control unit 310 to communicate over a local area network, the Internet, or a combination of both. The network module 314 can be a voice band modem configured to enable the alarm panel to communicate over the telephone lines of Plain Old Telephone Systems (“POTS”).

The control unit system that includes the control unit 310 can include one or more sensors 320. For example, the environment 300 can include multiple sensors 320. The sensors 320 can include a lock sensor, a contact sensor, a motion sensor, a camera (e.g., a camera 330), a flow meter, any other type of sensor included in a control unit system, or a combination of two or more of these. The sensors 320 can include an environmental sensor, such as a temperature sensor, a water sensor, a rain sensor, a wind sensor, a light sensor, a smoke detector, a carbon monoxide detector, or an air quality sensor, to name a few additional examples. The sensors 320 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heart-rate, respiration rate, sugar or glucose level, bodily temperature, motion data, or a combination of these. The sensors 320 can include a radio-frequency identification (“RFID”) sensor that identifies a particular article that includes a pre-assigned RFID tag.

The control unit 310 can communicates with a module 322 and a camera 330 to perform monitoring. The module 322 is connected to one or more devices that enable property automation, e.g., home or business automation. For instance, the module 322 can connect to, and be configured to control operation of, one or more lighting systems. The module 322 can connect to, and be configured to control operation of, one or more electronic locks, e.g., control Z-Wave locks using wireless communications in the Z-Wave protocol. In some examples, the module 322 can connect to, and be configured to control operation of, one or more appliances. The module 322 can include multiple sub-modules that are each specific to a type of device being controlled in an automated manner. The module 322 can control the one or more devices using commands received from the control unit 310. For instance, the module 322 can receive a command from the control unit 310, which command was sent using data captured by the camera 330 that depicts an area. In response, the module 322 can cause a lighting system to illuminate an area to provide better lighting in the area, and a higher likelihood that the camera 330 can capture a subsequent image of the area that depicts more accurate data of the area.

The camera 330 can be an image camera or other type of optical sensing device configured to capture one or more images. For instance, the camera 330 can be configured to capture images of an area within a property monitored by the control unit 310. The camera 330 can be configured to capture single, static images of the area; video of the area, e.g., a sequence of images; or a combination of both. The camera 330 can be controlled using commands received from the control unit 310 or another device in the property monitoring system, e.g., a device 350.

The camera 330 can be triggered using any appropriate techniques, can capture images continuous, or a combination of both. For instance, a Passive Infra-Red (“PIR”) motion sensor can be built into the camera 330 and used to trigger the camera 330 to capture one or more images when motion is detected. The camera 330 can include a microwave motion sensor built into the camera which sensor is used to trigger the camera 330 to capture one or more images when motion is detected. The camera 330 can have a “normally open” or “normally closed” digital input that can trigger capture of one or more images when external sensors detect motion or other events. The external sensors can include another sensor from the sensors 320, PIR, or door or window sensors, to name a few examples. In some implementations, the camera 330 receives a command to capture an image, e.g., when external devices detect motion or another potential alarm event or in response to a request from a device. The camera 330 can receive the command from the controller 312, directly from one of the sensors 320, or a combination of both.

In some examples, the camera 330 triggers integrated or external illuminators to improve image quality when the scene is dark. Some examples of illuminators can include Infra-Red, Z-wave controlled “white” lights, lights controlled by the module 322, or a combination of these. An integrated or separate light sensor can be used to determine if illumination is desired and can result in increased image quality.

The camera 330 can be programmed with any combination of time schedule, day schedule, system “arming state”, other variables, or a combination of these, to determine whether images should be captured when one or more triggers occur. The camera 330 can enter a low-power mode when not capturing images. In this case, the camera 330 can wake periodically to check for inbound messages from the controller 312 or another device. The camera 330 can be powered by internal, replaceable batteries, e.g., if located remotely from the control unit 310. The camera 330 can employ a small solar cell to recharge the battery when light is available. The camera 330 can be powered by a wired power supply, e.g., the controller's 312 power supply if the camera 330 is co-located with the controller 312.

In some implementations, the camera 330 communicates directly with the monitoring system 360 over the network 305. In these implementations, image data captured by the camera 330 need not pass through the control unit 310. The camera 330 can receive commands related to operation from the monitoring system 360, provide images to the monitoring system 360, or a combination of both.

The environment 300 can include one or more thermostats 334, e.g., to perform dynamic environmental control at the property. The thermostat 334 is configured to monitor temperature of the property, energy consumption of a heating, ventilation, and air conditioning (“HVAC”) system associated with the thermostat 334, or both. In some examples, the thermostat 334 is configured to provide control of environmental (e.g., temperature) settings. In some implementations, the thermostat 334 can additionally or alternatively receive data relating to activity at a property; environmental data at a property, e.g., at various locations indoors or outdoors or both at the property; or a combination of both. The thermostat 334 can measure or estimate energy consumption of the HVAC system associated with the thermostat. The thermostat 334 can estimate energy consumption, for example, using data that indicates usage of one or more components of the HVAC system associated with the thermostat 334. The thermostat 334 can communicate various data, e.g., temperature, energy, or both, with the control unit 310. In some examples, the thermostat 334 can control the environmental, e.g., temperature, settings in response to commands received from the control unit 310.

In some implementations, the thermostat 334 is a dynamically programmable thermostat and can be integrated with the control unit 310. For example, the dynamically programmable thermostat 334 can include the control unit 310, e.g., as an internal component to the dynamically programmable thermostat 334. In some examples, the control unit 310 can be a gateway device that communicates with the dynamically programmable thermostat 334. In some implementations, the thermostat 334 is controlled via one or more modules 322.

The environment 300 can include the HVAC system or otherwise be connected to the HVAC system. For instance, the environment 300 can include one or more HVAC modules 337. The HVAC modules 337 can be connected to one or more components of the HVAC system associated with a property. A module 337 can be configured to capture sensor data from, control operation of, or both, corresponding components of the HVAC system. In some implementations, the module 337 is configured to monitor energy consumption of an HVAC system component, for example, by directly measuring the energy consumption of the HVAC system components or by estimating the energy usage of the one or more HVAC system components by detecting usage of components of the HVAC system. The module 337 can communicate energy monitoring information, the state of the HVAC system components, or both, to the thermostat 334. The module 337 can control the one or more components of the HVAC system in response to receipt of commands received from the thermostat 334.

In some examples, the environment 300 includes one or more robotic devices 390. The robotic devices 390 can be any type of robots that are capable of moving, such as an aerial drone, a land-based robot, or a combination of both. The robotic devices 390 can taking actions, such as capture sensor data or other actions that assist in security monitoring, property automation, or a combination of both. For example, the robotic devices 390 can include robots capable of moving throughout a property using automated navigation control technology, user input control provided by a user, or a combination of both. The robotic devices 390 can fly, roll, walk, or otherwise move about the property. The robotic devices 390 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 390 can be robotic devices 390 that are intended for other purposes and merely associated with the environment 300 for use in appropriate circumstances. For instance, a robotic vacuum cleaner device can be associated with the environment 300 as one of the robotic devices 390 and can be controlled to take action responsive to monitoring system events.

In some examples, the robotic devices 390 automatically navigate within a property. In these examples, the robotic devices 390 include sensors and control processors that guide movement of the robotic devices 390 within the property. For instance, the robotic devices 390 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 390 can include control processors that process output from the various sensors and control the robotic devices 390 to move along a path that reaches the desired destination, avoids obstacles, or a combination of both. In this regard, the control processors detect walls or other obstacles in the property and guide movement of the robotic devices 390 in a manner that avoids the walls and other obstacles.

In some implementations, the robotic devices 390 can store data that describes attributes of the property. For instance, the robotic devices 390 can store a floorplan, a three-dimensional model of the property, or a combination of both, that enable the robotic devices 390 to navigate the property. During initial configuration, the robotic devices 390 can receive the data describing attributes of the property, determine a frame of reference to the data (e.g., a property or reference location in the property), and navigate the property using the frame of reference and the data describing attributes of the property. In some examples, initial configuration of the robotic devices 390 can include learning one or more navigation patterns in which a user provides input to control the robotic devices 390 to perform a specific navigation action (e.g., fly to an upstairs bedroom and spin around while capturing video and then return to a property charging base). In this regard, the robotic devices 390 can learn and store the navigation patterns such that the robotic devices 390 can automatically repeat the specific navigation actions upon a later request.

In some examples, the robotic devices 390 can include data capture devices. In these examples, the robotic devices 390 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 390 to take and store a biometric sample that can be used to identify the person (e.g., a biometric sample with DNA that can be used for DNA testing).

In some implementations, the robotic devices 390 can include output devices. In these implementations, the robotic devices 390 can include one or more displays, one or more speakers, any other type of output devices that allow the robotic devices 390 to communicate information, e.g., to a nearby user or another type of person, or a combination of these.

The robotic devices 390 can include a communication module that enables the robotic devices 390 to communicate with the control unit 310, each other, other devices, or a combination of these. The communication module can be a wireless communication module that allows the robotic devices 390 to communicate wirelessly. For instance, the communication module can be a Wi-Fi module that enables the robotic devices 390 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 390 to communicate with other devices, e.g., in or off the property. In some implementations, the robotic devices 390 can communicate with each other or with other devices of the environment 300 through the network 305.

The robotic devices 390 can include processor and storage capabilities. The robotic devices 390 can include any one or more suitable processing devices that enable the robotic devices 390 to execute instructions, operate applications, perform the actions described throughout this specification, or a combination of these. In some examples, the robotic devices 390 can include solid-state electronic storage that enables the robotic devices 390 to store applications, configuration data, collected sensor data, any other type of information available to the robotic devices 390, or a combination of two or more of these.

The robotic devices 390 can process captured data locally, provide captured data to one or more other devices for processing, e.g., the control unit 310 or the monitoring system 360, or a combination of both. For instance, the robotic device 390 can provide the images to the control unit 310 for processing. In some examples, the robotic device 390 can process the images to determine an identification of the items.

One or more of the robotic devices 390 can be associated with one or more charging stations. The charging stations can be located at a predefined home base or reference location in the property. The robotic devices 390 can be configured to navigate to one of the charging stations after completion of one or more tasks needed to be performed, e.g., for the environment 300. For instance, after completion of a monitoring operation or upon instruction by the control unit 310, a robotic device 390 can be configured to automatically fly to and connect with, e.g., land on, one of the charging stations. In this regard, a robotic device 390 can automatically recharge one or more batteries included in the robotic device 390 so that the robotic device 390 is less likely to need recharging when the environment 300 requires use of the robotic device 390, e.g., absent other concerns for the robotic device 390.

The charging stations can be contact-based charging stations, wireless charging stations, or a combination of both. For contact-based charging stations, the robotic devices 390 can have readily accessible points of contact to which a robotic device 390 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 390 can include a cover that opens to expose the electronic contact when the robotic device is charging and closes to cover and insulate the electronic contact when the robotic device 390 is in operation.

For wireless charging stations, the robotic devices 390 can charge through a wireless exchange of power. In these cases, a robotic device 390 needs only position itself closely enough to a wireless charging station for the wireless exchange of power to occur. In this regard, the positioning needed to land at a predefined home base or reference location in the property can be less precise than with a contact-based charging station. Based on the robotic devices 390 landing at a wireless charging station, the wireless charging station can output a wireless signal that the robotic device 390 receives and converts to a power signal that charges a battery maintained on the robotic device 390. As described in this specification, a robotic device 390 landing or coupling with a charging station can include a robotic device 390 positioning itself within a threshold distance of a wireless charging station such that the robotic device 390 is able to charge its battery.

In some implementations, one or more of the robotic devices 390 has an assigned charging station. In these implementations, the number of robotic devices 390 can equal the number of charging stations. In these implementations, the robotic devices 390 can always navigate to the specific charging station assigned to that robotic device 390. For instance, a first robotic device can always use a first charging station and a second robotic device can always use a second charging station.

In some examples, the robotic devices 390 can share charging stations. For instance, the robotic devices 390 can use one or more community charging stations that are capable of charging multiple robotic devices 390, e.g., substantially concurrently or separately or a combination of both at different times. The community charging station can be configured to charge multiple robotic devices 390 at substantially the same time, e.g., the community charging station can begin charging a first robotic device and then, while charging the first robotic device, begin charging a second robotic device five minutes later. The community charging station can be configured to charge multiple robotic devices 390 in serial such that the multiple robotic devices 390 take turns charging and, when fully charged, return to a predefined home base or reference location or another location in the property that is not associated with a charging station. The number of community charging stations can be less than the number of robotic devices 390.

In some instances, the charging stations might not be assigned to specific robotic devices 390 and can be capable of charging any of the robotic devices 390. In this regard, the robotic devices 390 can use any suitable, unoccupied charging station when not in use, e.g., when not performing an operation for the environment 300. For instance, when one of the robotic devices 390 has completed an operation or is in need of battery charge, the control unit 310 can reference a stored table of the occupancy status of each charging station and instructs the robotic device to navigate to the nearest charging station that has at least one unoccupied charger.

The environment 300 can include one or more integrated security devices 380. The one or more integrated security devices can include any type of device used to provide alerts based on received sensor data. For instance, the one or more control units 310 can provide one or more alerts to the one or more integrated security input/output devices 380. In some examples, the one or more control units 310 can receive sensor data from the sensors 320 and determine whether to provide an alert, or a message to cause presentation of an alert, to the one or more integrated security input/output devices 380.

The sensors 320, the module 322, the camera 330, the thermostat 334, and the integrated security devices 380 can communicate with the controller 312 over communication links 324, 326, 328, 332, 338, 384, and 386. The communication links 324, 326, 328, 332, 338, 384, and 386 can be a wired or wireless data pathway configured to transmit signals between any combination of the sensors 320, the module 322, the camera 330, the thermostat 334, the robotic devices 390, the integrated security devices 380, or the controller 312. The sensors 320, the module 322, the camera 330, the thermostat 334, the robotic devices 390, and the integrated security devices 380 can continuously transmit sensed values to the controller 312, periodically transmit sensed values to the controller 312, or transmit sensed values to the controller 312 in response to a change in a sensed value, a request, or both. In some implementations, the robotic devices 390 can communicate with the monitoring system 360 over network 305. The robotic devices 390 can connect and communicate with the monitoring system 360 using a Wi-Fi or a cellular connection or any other appropriate type of connection.

The communication links 324, 326, 328, 332, 338, 384, and 386 can include any appropriate type of network, such as a local network. The sensors 320, the module 322, the camera 330, the thermostat 334, the robotic devices 390 and the integrated security devices 380, and the controller 312 can exchange data and commands over the network.

The monitoring system 360 can include one or more electronic devices, e.g., one or more computers. The monitoring system 360 is configured to provide monitoring services by exchanging electronic communications with the control unit 310, the one or more devices 340 and 350, the central alarm station server 370, or a combination of these, over the network 305. For example, the monitoring system 360 can be configured to monitor events (e.g., alarm events) generated by the control unit 310. In this example, the monitoring system 360 can exchange electronic communications with the network module 314 included in the control unit 310 to receive information regarding events (e.g., alerts) detected by the control unit 310. The monitoring system 360 can receive information regarding events (e.g., alerts) from the one or more devices 340 and 350.

In some implementations, the monitoring system 360 might be configured to provide one or more services other than monitoring services. In these implementations, the monitoring system 360 might perform one or more operations described in this specification without providing any monitoring services, e.g., the monitoring system 360 might not be a monitoring system as described in the example shown in FIG. 3.

In some examples, the monitoring system 360 can route alert data received from the network module 314 or the one or more devices 340 and 350 to the central alarm station server 370. For example, the monitoring system 360 can transmit the alert data to the central alarm station server 370 over the network 305.

The monitoring system 360 can store sensor and image data received from the environment 300 and perform analysis of sensor and image data received from the environment 300. Based on the analysis, the monitoring system 360 can communicate with and control aspects of the control unit 310 or the one or more devices 340 and 350.

The monitoring system 360 can provide various monitoring services to the environment 300. For example, the monitoring system 360 can analyze the sensor, image, and other data to determine an activity pattern of a person of the property monitored by the environment 300. In some implementations, the monitoring system 360 can analyze the data for alarm conditions or can determine and perform actions at the property by issuing commands to one or more components of the environment 300, possibly through the control unit 310.

The central alarm station server 370 is an electronic device, or multiple electronic devices, configured to provide alarm monitoring service by exchanging communications with the control unit 310, the one or more mobile devices 340 and 350, the monitoring system 360, or a combination of these, over the network 305. For example, the central alarm station server 370 can be configured to monitor alerting events generated by the control unit 310. In this example, the central alarm station server 370 can exchange communications with the network module 314 included in the control unit 310 to receive information regarding alerting events detected by the control unit 310. The central alarm station server 370 can receive information regarding alerting events from the one or more mobile devices 340 and 350, the monitoring system 360, or both.

The central alarm station server 370 is connected to multiple terminals 372 and 374. The terminals 372 and 374 can be used by operators to process alerting events. For example, the central alarm station server 370, e.g., as part of a first responder system, can route alerting data to the terminals 372 and 374 to enable an operator to process the alerting data. The terminals 372 and 374 can include general-purpose computers (e.g., desktop personal computers, workstations, or laptop computers) that are configured to receive alerting data from a computer in the central alarm station server 370 and render a display of information using the alerting data.

For instance, the controller 312 can control the network module 314 to transmit, to the central alarm station server 370, alerting data indicating that a sensor 320 detected motion from a motion sensor via the sensors 320. The central alarm station server 370 can receive the alerting data and route the alerting data to the terminal 372 for processing by an operator associated with the terminal 372. The terminal 372 can render a display to the operator that includes information associated with the alerting event (e.g., the lock sensor data, the motion sensor data, the contact sensor data, etc.) and the operator can handle the alerting event based on the displayed information. In some implementations, the terminals 372 and 374 can be mobile devices or devices designed for a specific function. Although FIG. 3 illustrates two terminals for brevity, actual implementations can include more (and, perhaps, many more) terminals.

The one or more devices 340 and 350 are devices that can present content, e.g., host and display user interfaces, audio data, or both. For instance, the mobile device 340 is a mobile device that hosts or runs one or more native applications (e.g., the smart property application 342). The mobile device 340 can be a cellular phone or a non-cellular locally networked device with a display. The mobile device 340 can include a cell phone, a smart phone, a tablet PC, a personal digital assistant (“PDA”), or any other portable device configured to communicate over a network and present information. The mobile device 340 can perform functions unrelated to the monitoring system, such as placing personal telephone calls, playing music, playing video, displaying pictures, browsing the Internet, and maintaining an electronic calendar.

The mobile device 340 can include a smart property application 342. The smart property application 342 refers to a software/firmware program running on the corresponding mobile device that enables the user interface and features described throughout. The mobile device 340 can load or install the smart property application 342 using data received over a network or data received from local media. The smart property application 342 enables the mobile device 340 to receive and process image and sensor data from the monitoring system 360.

The device 350 can be a general-purpose computer (e.g., a desktop personal computer, a workstation, or a laptop computer) that is configured to communicate with the monitoring system 360, the control unit 310, or both, over the network 305. The device 350 can be configured to display a smart property user interface 352 that is generated by the device 350 or generated by the monitoring system 360. For example, the device 350 can be configured to display a user interface (e.g., a web page) generated using data provided by the monitoring system 360 that enables a user to perceive images captured by the camera 330, reports related to the monitoring system, or both. Although FIG. 3 illustrates two devices for brevity, actual implementations can include more (and, perhaps, many more) or fewer devices.

In some implementations, the one or more devices 340 and 350 communicate with and receive data from the control unit 310 using the communication link 338. For instance, the one or more devices 340 and 350 can communicate with the control unit 310 using various wireless protocols, or wired protocols such as Ethernet and USB, to connect the one or more devices 340 and 350 to the control unit 310, e.g., local security and automation equipment. The one or more devices 340 and 350 can use a local network, a wide area network, or a combination of both, to communicate with other components in the environment 300. The one or more devices 340 and 350 can connect locally to the sensors and other devices in the environment 300.

Although the one or more devices 340 and 350 are shown as communicating with the control unit 310, the one or more devices 340 and 350 can communicate directly with the sensors and other devices controlled by the control unit 310. In some implementations, the one or more devices 340 and 350 replace the control unit 310 and perform one or more of the functions of the control unit 310 for local monitoring and long range, offsite, or both, communication.

In some implementations, the one or more devices 340 and 350 receive monitoring system data captured by the control unit 310 through the network 305. The one or more devices 340 and 350 can receive the data from the control unit 310 through the network 305, the monitoring system 360 can relay data received from the control unit 310 to the one or more devices 340 and 350 through the network 305, or a combination of both. In this regard, the monitoring system 360 can facilitate communication between the one or more devices 340 and 350 and various other components in the environment 300.

In some implementations, the one or more devices 340 and 350 can be configured to switch whether the one or more devices 340 and 350 communicate with the control unit 310 directly (e.g., through communication link 338) or through the monitoring system 360 (e.g., through network 305) based on a location of the one or more devices 340 and 350. For instance, when the one or more devices 340 and 350 are located close to, e.g., within a threshold distance of, the control unit 310 and in range to communicate directly with the control unit 310, the one or more devices 340 and 350 use direct communication. When the one or more devices 340 and 350 are located far from, e.g., outside the threshold distance of, the control unit 310 and not in range to communicate directly with the control unit 310, the one or more devices 340 and 350 use communication through the monitoring system 360.

Although the one or more devices 340 and 350 are shown as being connected to the network 305, in some implementations, the one or more devices 340 and 350 are not connected to the network 305. In these implementations, the one or more devices 340 and 350 communicate directly with one or more of the monitoring system components and no network (e.g., Internet) connection or reliance on remote servers is needed.

In some implementations, the one or more devices 340 and 350 are used in conjunction with only local sensors and/or local devices in a house. In these implementations, the environment 300 includes the one or more devices 340 and 350, the sensors 320, the module 322, the camera 330, and the robotic devices 390. The one or more devices 340 and 350 receive data directly from the sensors 320, the module 322, the camera 330, the robotic devices 390, or a combination of these, and send data directly to the sensors 320, the module 322, the camera 330, the robotic devices 390, or a combination of these. The one or more devices 340 and 350 can provide the appropriate interface, processing, or both, to provide visual surveillance and reporting using data received from the various other components.

In some implementations, the environment 300 includes network 305 and the sensors 320, the module 322, the camera 330, the thermostat 334, and the robotic devices 390 are configured to communicate sensor and image data to the one or more devices 340 and 350 over network 305. In some implementations, the sensors 320, the module 322, the camera 330, the thermostat 334, and the robotic devices 390 are programmed, e.g., intelligent enough, to change the communication pathway from a direct local pathway when the one or more devices 340 and 350 are in close physical proximity to the sensors 320, the module 322, the camera 330, the thermostat 334, the robotic devices 390, or a combination of these, to a pathway over network 305 when the one or more devices 340 and 350 are farther from the sensors 320, the module 322, the camera 330, the thermostat 334, the robotic devices 390, or a combination of these.

In some examples, the monitoring system 360 leverages GPS information from the one or more devices 340 and 350 to determine whether the one or more devices 340 and 350 are close enough to the sensors 320, the module 322, the camera 330, the thermostat 334, the robotic devices 390, or a combination of these, to use the direct local pathway or whether the one or more devices 340 and 350 are far enough from the sensors 320, the module 322, the camera 330, the thermostat 334, the robotic devices 390, or a combination of these, that the pathway over network 305 is required. In some examples, the monitoring system 360 leverages status communications (e.g., pinging) between the one or more devices 340 and 350 and the sensors 320, the module 322, the camera 330, the thermostat 334, the robotic devices 390, or a combination of these, to determine whether communication using the direct local pathway is possible. If communication using the direct local pathway is possible, the one or more devices 340 and 350 communicate with the sensors 320, the module 322, the camera 330, the thermostat 334, the robotic devices 390, or a combination of these, using the direct local pathway. If communication using the direct local pathway is not possible, the one or more devices 340 and 350 communicate with the sensors 320, the module 322, the camera 330, the thermostat 334, the robotic devices 390, or a combination of these, using the pathway over network 305.

In some implementations, the environment 300 provides people with access to images captured by the camera 330 to aid in decision-making. The environment 300 can transmit the images captured by the camera 330 over a network, e.g., a wireless WAN, to the devices 340 and 350. Because transmission over a network can be relatively expensive, the environment 300 can use several techniques to reduce costs while providing access to significant levels of useful visual information (e.g., compressing data, down-sampling data, sending data only over inexpensive LAN connections, or other techniques).

In some implementations, a state of the environment 300, one or more components in the environment 300, and other events sensed by a component in the environment 300 can be used to enable/disable video/image recording devices (e.g., the camera 330). In these implementations, the camera 330 can be set to capture images on a periodic basis when the alarm system is armed in an “away” state, set not to capture images when the alarm system is armed in a “stay” state or disarmed, or a combination of both. In some examples, the camera 330 can be triggered to begin capturing images when the control unit 310 detects an event, such as an alarm event, a door-opening event for a door that leads to an area within a field of view of the camera 330, or motion in the area within the field of view of the camera 330. In some implementations, the camera 330 can capture images continuously, but the captured images can be stored or transmitted over a network when needed.

Although FIG. 3 depicts the monitoring system 360 as remote from the control unit 310, in some examples the control unit 310 can be a component of the monitoring system 360. For instance, both the monitoring system 360 and the control unit 310 can be physically located at a property that includes the sensors 320 or at a location outside the property.

In some examples, some of the sensors 320, the robotic devices 390, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 310, the monitoring system 360, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some cases, multitasking and parallel processing may be advantageous.

1. A computer-implemented method comprising:
receiving, from a sound sensing device at a property, an audio signal captured by the sound sensing device;
obtaining, from one or more other devices at the property, data;
determining whether an audio event likely occurred at the property using the obtained data;
in response to determining that an audio event likely occurred at the property, determining, using the audio signal captured by the sound sensing device and event data for the audio event, whether a configuration of the sound sensing device is likely modified; and
in response to determining that the configuration of the sound sensing device is likely modified, performing one or more actions for the modification of the configuration of the sound sensing device at the property.

2. The computer-implemented method of claim 1, wherein:
receiving the audio signal captured by the sound sensing device comprises receiving, from the sound sensing device at the property, the audio signal that has a decibel level; and
determining whether the configuration of the sound sensing device is likely modified comprises:
determining, using a type of the audio event, a decibel threshold for the type of the audio event;
determining whether the decibel level satisfies the decibel threshold; and
determining whether the configuration of the sound sensing device is likely modified using a result of the determination whether the decibel level satisfies the decibel threshold.

3. The computer-implemented method of claim 2, wherein the audio signal with the decibel level was captured during a period of time during which the data was obtained.

4. The computer-implemented method of claim 2, wherein the audio signal has a plurality of decibel levels across a period of time during which it was captured, the method comprising selecting, as the decibel level, a maximum decibel level from the plurality of decibel levels.

5. The computer-implemented method of claim 1, wherein determining whether the configuration of the sound sensing device is likely modified comprises:
providing, to a calibration model configured to produce a likelihood that a respective audio signal matches to one or more calibrated audio signals for the sound sensing device, data representative of the audio signal;
receiving, from the calibration model, an output that represents a likelihood that the received audio signal matches a calibrated audio signal;
determining whether the likelihood satisfies a likelihood threshold; and
in response to determining that the likelihood satisfies the likelihood threshold, determining that the sound sensing device is likely modified.

6. The computer-implemented method of claim 5, wherein determining that the sound sensing device is likely modified comprises:
determining a difference between the received audio signal to the calibrated audio signal; and
using the difference between the received audio signal and the calibrated audio signal, determining that the sound sensing device is likely modified.

7. The computer-implemented method of claim 5, comprising:
determining at least one of (i) a particular noise event from the obtained data or (ii) the device associated with the particular noise event;
selecting, from a plurality of calibrated audio signals, the calibrated audio signal using at least one of the particular noise event or the device associated with the particular noise event; and
providing, to the calibration model, data for the calibrated audio signal.

8. The computer-implemented method of claim 1, determining, using the audio signal captured by the sound sensing device, whether a configuration of the sound sensing device is likely modified comprises:
determining whether a difference between at least a portion of the audio signal and an event audio signature for the audio event satisfies a difference threshold; and
in response to determining that the difference does not satisfy the difference threshold, determining that the sound sensing devices is likely modified.

9. The computer-implemented method of claim 1, wherein determining whether the configuration of the sound sensing device is likely modified comprises at least one of determining whether the sound sensing device is encased, determining whether the sound sensing device has been tampered with, determining whether the sound sensing device has been relocated, or determining whether the sound sensing device has been turned off.

10. The computer-implemented method of claim 1, further comprising:
generating a calibrated model comprising training a machine learning model to calibrate to noises heard by the sound sensing device, wherein the training is performed by:
receiving, while the sound sensing device is at a location at the property, audio signals encoding sound captured by the sound sensing device at the location at the property;
labeling at least portions of the audio signals with identifiers that indicate devices that caused the noises at the property; and
for each labeled identifier, providing data indicative of the portion of the audio signal and the label to the machine learning model to train the model to recognize the portion of the audio signal.

11. The computer-implemented method of claim 1, wherein performing the one or more actions to for the modification of the configuration of the sound sensing device at the property comprises:
adjusting a weight for the sound sensing device; and
determining whether to perform an action for the property using at least the audio signal, and the adjusted weight.

12. The computer-implemented method of claim 11, wherein determining whether to perform an action for the property uses at least the audio signal, the adjusted weight, and additional sensor data captured by another sensor at the property.

13. The computer-implemented method of claim 1, wherein determining whether the configuration of the sound sensing device is likely modified comprises:
monitoring, using noises captured by one or more sound sensing device at the property, an ambient noise of the property;
determining whether the monitored ambient noise of the property satisfies an ambient noise threshold; and
in response to determining that the monitored ambient noise of the property does not satisfy the ambient noise threshold, determining that the configuration of the sound sensing device is likely modified.

14. The computer-implemented method of claim 1, further comprising:
receiving, from the sound sensing device, temperature data for the sound sensing device that was captured while the sound sensing device was in use; and
determining whether the temperature data satisfies a temperature threshold, wherein:
determining that the configuration of the sound sensing device is likely modified is responsive to determining that the received temperature data does not satisfy the temperature threshold value.

15. The computer-implemented method of claim 1, further comprising:
receiving, from the sound sensing device, data indicative of a fan speed of a fan onboard the sound sensing device that was captured while the sound sensing device was in use; and
determining whether the received data indicative of the fan speed satisfies a speed threshold, wherein:
determining that the configuration of the sound sensing device is likely modified is responsive to determining that the received data indicative of the fan speed does not satisfy the speed threshold.

16. One or more computer storage media encoded with instructions that, when executed by one or more computers, cause the one or more computers to perform operations comprising:
receiving, from a sound sensing device at a property, an audio signal captured by the sound sensing device;
obtaining, from one or more other devices at the property, data;
determining whether an audio event likely occurred at the property using the obtained data;
in response to determining that an audio event likely occurred at the property, determining, using the audio signal captured by the sound sensing device and event data for the audio event, whether a configuration of the sound sensing device is likely modified; and
in response to determining that the configuration of the sound sensing device is likely modified, performing one or more actions for the modification of the configuration of the sound sensing device at the property.

17. The one or more computer storage media of claim 16, wherein:
receiving the audio signal captured by the sound sensing device comprises receiving, from the sound sensing device at the property, the audio signal that has a decibel level; and
determining whether the configuration of the sound sensing device is likely modified comprises:
determining, using a type of the audio event, a decibel threshold for the type of the audio event;
determining whether the decibel level satisfies the decibel threshold; and
determining whether the configuration of the sound sensing device is likely modified using a result of the determination whether the decibel level satisfies the decibel threshold.

18. The one or more computer storage media of claim 17, wherein the audio signal with the decibel level was captured during a period of time during which the data was obtained.

19. The one or more computer storage media of claim 17, wherein the audio signal has a plurality of decibel levels across a period of time during which it was captured, the method comprising selecting, as the decibel level, a maximum decibel level from the plurality of decibel levels.

20. A system comprising one or more computers and one or more storage devices on which are stored instructions that are operable, when executed by the one or more computers, to cause the one or more computers to perform operations comprising:
receiving, from a sound sensing device at a property, an audio signal captured by the sound sensing device;
obtaining, from one or more other devices at the property, data;
determining whether an audio event likely occurred at the property using the obtained data;
in response to determining that an audio event likely occurred at the property, determining, using the audio signal captured by the sound sensing device and event data for the audio event, whether a configuration of the sound sensing device is likely modified; and
in response to determining that the configuration of the sound sensing device is likely modified, performing one or more actions for the modification of the configuration of the sound sensing device at the property.
